(19) United States
(12) Patent Application Publication
(10) Pub. No.: US 2006/0151308 A1
(43) Pub. Date: Jul. 13, 2006

(54) Proportional input interface

(76) Inventors: George Marmaropoulos, Yorktown Heights, NY (US); Mama Jack Kyriakos, London (GB); Giang Vu, New York, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/560,707

(22) PCT Filed: Jun. 28, 2004
(86) PCT No.: PCT/IB04/51031

§ 371 Date: Dec. 15, 2005

Related U.S. Application Data
(60) Provisional application No. 60/483,771, filed on Jun. 30, 2003.

(51) Int. Cl. H01H 1/10

(52) U.S. Cl. 200/512; 200/514

(57) ABSTRACT

There is provided a flexible, lightweight high-performance proportional input interface (10) cooperative with a textile garment or upholstery as well as with any of a variety of different electronics (50) without compromising the comfort and/or durability of the textile (1). The proportional input interface (10) has one or more areas of a conductive elastomeric material (20) that cooperate with an actuator (30) to translate and/or communicate intuitive user input proportionally to the one or more areas of conductive elastomeric material (20) such that the user input can be converted and/or altered into a signal suitable for accomplishing one more complicated functions and/or operations associated with various electronic devices and/or systems (50).

The present invention relates to textile electronics. More particularly, the present invention relates to an input device integrated into a flexible textile electronic circuit, or the like, for detecting proportional input from one or more diverse directions and cooperative with various textile electronic applications and/or operations.

The use of electronics in various manufactured materials is well known; see for example, U.S. Pat. Nos. 6,360,615 B1, 6,210,771 B1, and 5,371,326; U.S. Patent Application Publication No. 2002/0135457 A1; PCT International Patent Publication Nos. WO 02/055923 A1 and WO 02/32665 A1; and/or UK Patent Application No. GB 2 373 863. Devices such as conductive traces, bio-sensors, electrodes, computers, electronic circuits and the like have all been incorporated into textiles. As the benefits associated with the various types and/or configurations of textile electronics become more apparent, the desirability and need for simple, effective and efficient, as well as intuitive user interface solutions becomes more apparent. Hence, there is a need for an input device or interface that is complementary to the various electronic functions/systems provided by the different textile electronics and/or the materials accommodating such electronics.

It is an object of the present invention to provide an interface suitable to address the above-identified need for simple, effective and efficient, as well as intuitive user interface solutions.

It is another object of the present invention to provide such an interface that has a flexible textile construction.

It is another object of the present invention to provide such an interface that can be proportionally manipulated.

It is another object of the present invention to provide such an interface having an actuating member for cooperating with one or more areas of conductive variable resistance elastomeric material.

It is a further object of the present invention to provide such an interface that can cooperate with a garment, upholstery, and/or various electronic devices/systems.

It is another object of the present invention to provide such an interface that is suitable for facilitating intuitive user interface solutions for textile electronics.

It is still another object of the present invention to provide such an interface suitable for accomplishing a variety of relatively sophisticated operations/functions.

These and other objects and advantages of the present invention are achieved by an input device or interface having a fabric or textile construction fashioned from at least a conductive elastomeric material suitable for converting motion into a signal, and an actuator for cooperating with the conductive elastomeric material to provide an intuitive user interface. The interface can take the form of any number of electronic switches and/or controls suitable for providing user interface solutions for different textile electronics and/or related devices/systems/equipment. The conductive elastomeric material can be selectively and/or proportionally manipulated to facilitate accomplishing one or more relatively complicated electronic functions/operations. The manipulation of the conductive elastomeric material by, for example, an interaction, can be detected via the relative properties or characteristics of one or more areas of the conductive elastomeric material.

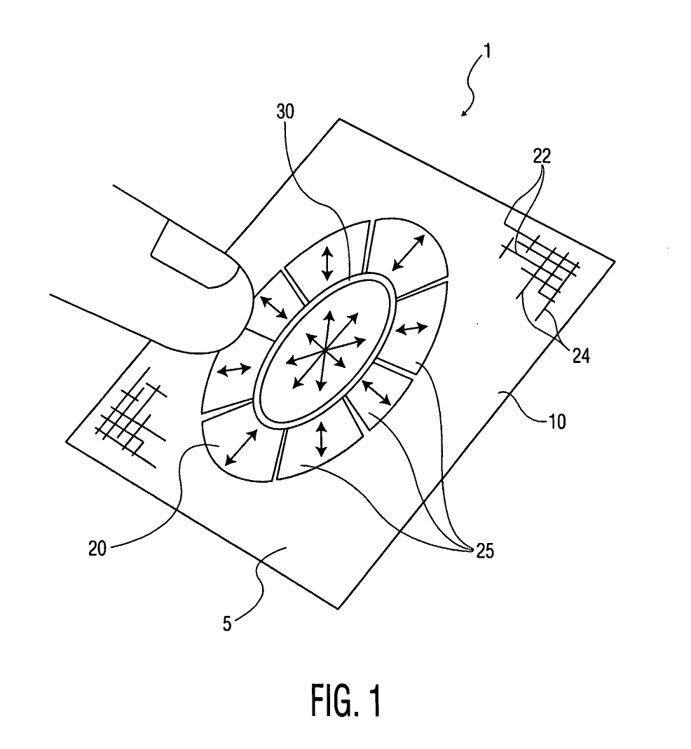

FIG. 1 is a plan perspective view of a proportional input interface in accordance with an illustrative embodiment of the present invention;

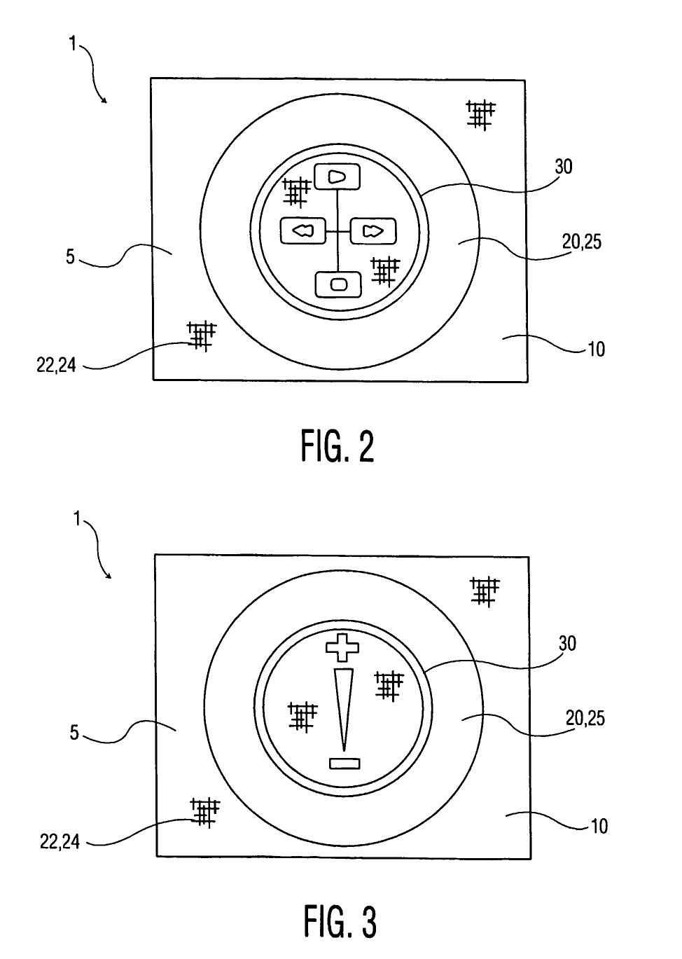

FIG. 2 is a plan view of a proportional input interface in accordance with another illustrative embodiment of the present invention with the interface being in an inoperative or non-use state;

FIG. 3 is a plan view of a proportional input interface in accordance with still another illustrative embodiment of the present invention with the interface being in an inoperative or non-use state

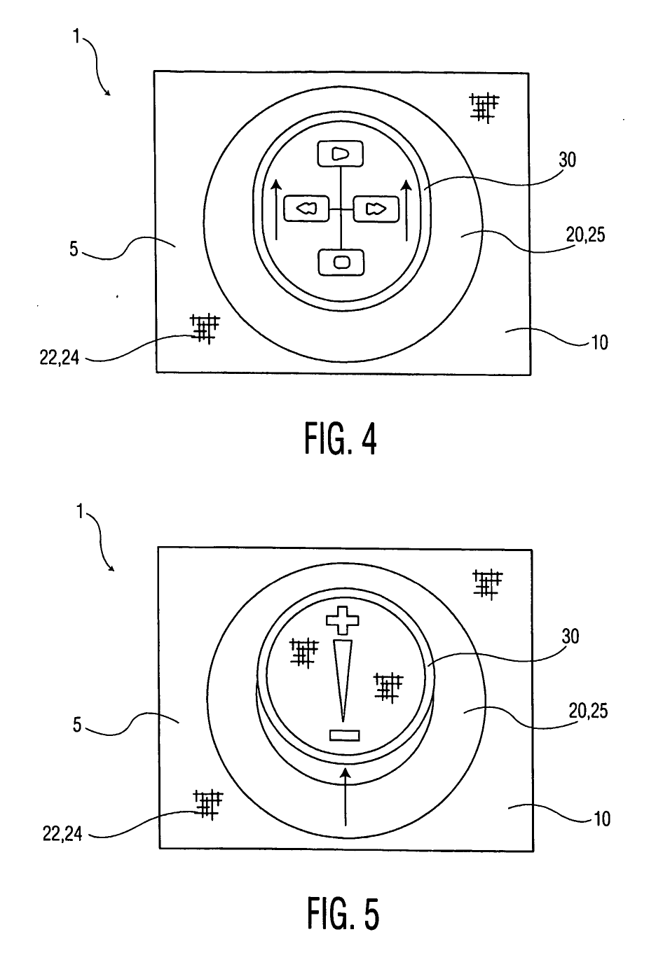

FIG. 4 is a plan view of the proportional input interface of FIG. 2 with the interface being in a manipulated or operative state;

FIG. 5 is a plan view the proportional input interface of FIG. 3 with the interface being in a manipulated or operative state; and

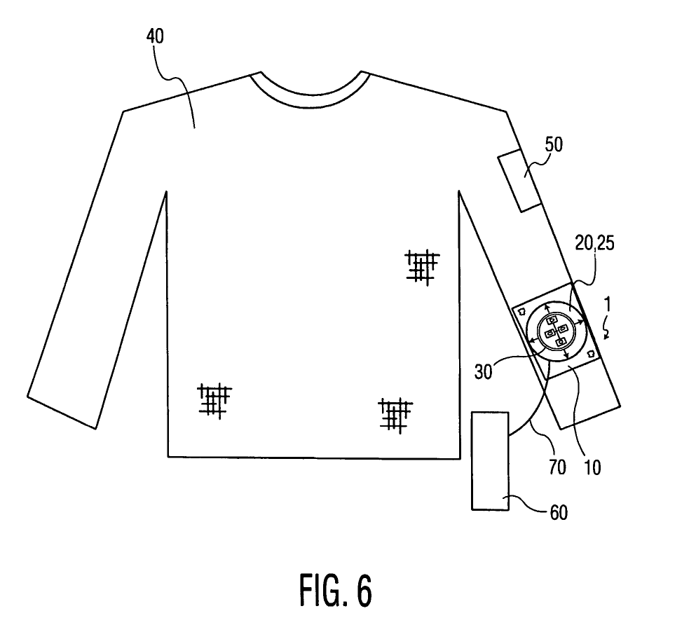

FIG. 6 is a front view of a garment incorporating the proportional input interface in accordance with another illustrative embodiment of the present invention.

Referring to the drawings and, in particular, FIG. 1, a textile having a fiber mesh or construction in accordance with an illustrative embodiment of the present invention is shown and generally represented by reference numeral 1. Preferably, textile construction 1 is fashioned with an input device or interface 10 having one or more areas of conductive elastomeric material 20 suitable for converting a mechanical interaction or motion into a signal via the properties or characteristics of such material. The textile construction 1 preferably also has an actuator 30 cooperative with the one or more areas of conductive elastomeric material 20 to translate and/or communicate any interaction or user input to the conductive elastomeric material 20.

Referring to FIGS. 1 through 3, the interface 10 preferably can be formed into a multitude of different patterns facilitating a variety of different applications in use. The interface 10 preferably can cooperate with a variety of different electronic devices/systems, such as for example, various wearable electronics, biosensors, medical instruments, or health therapy equipment. The interface 10 may also operate independently to accomplish a variety of different electronic operations. The interface 10, in addition to the conductive elastomeric material 20 and the actuator 30, can have any number of other materials and/or elements appropriate for forming one or more electronic switches and/or controls. Moreover, the interface 10 can be any desired shape, size and/or configuration necessary for facilitating a multitude of electronic operations/functions.

Preferably, the one or more areas of conductive elastomeric material 20 have one or more conductive and/or physical characteristics that change in response to being stretched or manipulated in some fashion. For example, the conductive elastomeric material 20 can have piezoelectric characteristics such as those provided by any of the following known materials: a polypyrrole/lycra material, a polypyrrole/nylon material, a polypyrrole/polyester material, or any conjugated polymer, and ion-implanted polymers, or any combination of such materials. The conductive elastomeric material 20 can also be selected from one or more of the following types and/or combinations of material: a flexible metal coated fabric including woven, non-woven, and/or knit, filaments, foils, and yarns, a conductive polymer coated fiber/fabric, a conductive graphitized fiber/fabric, or a conductive gel coated fiber/fabric. The conductive elastomeric material 20 preferably has characteristics suitable to provide appropriate flexibility and durability to withstand the stresses associated with the manufacture and use of a variety of different types of textile constructions.

Preferably, the conductive elastomeric material 20 can also facilitate electrical communication between an electrical power source 60 and the interface 10 via the textile construction 1. Preferably, the interface 10 can, in turn, facilitate power being provided to any of a variety of textile electronics. A connector 70 preferably can provide a medium for the electrical communication between the electrical power source and the textile construction 1. The connector 70 can have any configuration suitable to provide the means or way for this electrical communication. The conductive elastomeric material 20 can also have any of a variety of different shapes, sizes or configurations so that the interface 10 can be adapted to accommodate different uses.

It is noted that the conductive elastomeric material 20 can also be fashioned from a combination of conductive fibers 22 and non-conductive fibers 24 using any known conventional method for weaving, sewing and/or knitting. Preferably each conductive fiber 22 can have any of a variety of forms. For example, conductive fibers 22 can have a conductive threadlike core enclosed by a conductive semi-fluid sleeve. The core and sleeve preferably being bonded together via sonic welding. It is noted that other connecting methods may also be used. Conductive fibers 22 can be any of a variety of materials and/or combination of materials. For example, conductive fibers 22 can be fashioned from metalized foils, conductive polymers, graphitized/metalized fibers, or conductive gels (e.g., conductive silicon), or any combination of the same. Preferably, each non-conductive fiber can have, in addition to an appropriate amount of elasticity and/or extensibility, properties that facilitate comfortable interaction with the skin, such as for example, lycra, spandex, neoprene, polyester, and/or a rubber extruded fibers. Non-conductive fibers 24 can also preferably have different shapes, sizes or configurations such that interface 10 can have different adaptations to accommodate different uses. It is noted that not all of the non-conductive fibers 24 need have elastomeric properties and that a composite of elastomeric fibers and non-elastomeric materials may also be used to accomplish the intended purposes of the present invention.

Referring generally to FIGS. 1 through 5, actuator 30 preferably cooperates with the one or more areas of conductive elastomeric material 20 to facilitate converting a motion or mechanical interaction into a signal for affecting and/or effecting an electronic operation/function. Preferably, the actuator 30 is formed from a relatively rigid material such as, for example, a plastic, a rubber, a combination of plastic and rubber, or any similar material suitable for fashioning the interface 10 of the present invention. Preferably, the actuator 30 is annular and is in at least close proximity with the one or more areas of conductive elastomeric material 20. The actuator 30 can also be in direct contact, or even integral with the one or more areas of conductive elastomeric material 20.

Preferably, the one or more areas of conductive elastomeric material 20 have properties or characteristics (e.g., resistance, capacity, etc.) that change in response to an interaction via the interface 10. This interaction can be brought about via a user through some peripheral means or via actuator 30. Thus, any relative movement of said one or more areas 25 of conductive elastomeric material is detectable via a change in the characteristics the one or more areas 25 thereof. Preferably, the displacement ratio between the one or more areas 25 of the conductive elastomeric material 20 can be used to quantify the degree of the interaction and/or to quantify the speed or rate of the interaction.

Accordingly, the interface 10 is suitable for use in a variety of different wearable electronic applications and/or for accomplishing one or more different complex functionalities requiring proportional input. The interface 10 of the present invention is preferably a highly flexible/resilient, lightweight high-performance intuitive user interface that can cooperate with a textile as well as with any of a variety of different textile electronics and the like without compromising the physical characteristics (e.g., comfort and/or durability) associated with the textile.

Having described some of the preferred characteristics of an illustrative embodiment, the process or method for forming a flexible textile interface 10, preferably includes fashioning an interface 10 from a conductive elastomeric textile 1 such as those previously identified. Next, providing the interface 10 with an actuator 30 for cooperating with one or more conductive areas 20 of said interface 10. The actuator 30 can be permanently embedded into or integral with the conductive elastomeric textile 1 proximate the one or more conductive areas 20 of said interface. The actuator 30 and/or the interface 10 can also be attached to a surface 5 of the conductive elastomeric textile 1 via any suitable method known in the art, such as for example, knitting, embroidering, weaving or laminating.

Referring to FIG. 6, preferably, the interface 10 can, in turn, be either connected to, or integral with, a garment 40 or upholstery suitable for cooperating with one or more electronic devices and/or systems 50. The connecting/integrating of the interface 10 to/with the garment 40 can be accomplished in any manner known in the art for accomplishing such operations.

The present invention having been thus described with particular reference to certain illustrative forms thereof, it will be obvious that various changes and modifications may be made therein without departing from the spirit of the present invention as defined herein.

What is claimed is:

1. A textile construction (1), comprising:
a conductive elastomeric material (20) suitable for converting an interaction therewith into a signal; and
an actuator (30) cooperative with said conductive elastomeric material (20) to provide an intuitive user interface (10).

2. The textile construction (1) of claim 1, wherein one or more characteristics of said conductive elastomeric material (20) change in response to said interaction.

3. The textile construction (1) of claim 1, wherein said conductive elastomeric material (20) has piezoelectric characteristics.

4. The textile construction (1) of claim 1, wherein said conductive elastomeric material (20) is a polypyrrole/lycra, a polypyrrole/nylon, a polypyrrole/polyester, or any other conjugated polymer, or ion-implanted polymer, or any combination of the same.

5. The textile construction (1) of claim 1, wherein said conductive elastomeric material (20) can have one or more of the following: a flexible metal coated fabric including woven, non-woven, and/or knit, filaments, foils, and yarns, a conductive polymer coated fiber/fabric, a conductive graphitized fiber/fabric, or a conductive gel coated fiber/fabric, and/or any combination of the same.

6. The textile construction (1) of claim 1, wherein said actuator (30) is formed from a relatively rigid material.

7. The textile construction (1) of claim 1, wherein said actuator (30) is formed from plastic or rubber or some combination thereof.

8. The textile construction (1) of claim 1, wherein said actuator (30) is cooperative with said conductive elastomeric material (20).

9. The textile construction (1) of claim 1, wherein one or more characteristics of said conductive elastomeric material (20) change in proportional response to said interaction, said interaction causing one or more areas (25) of said conductive elastomeric material (20) to be displaced.

10. A multi-direction proportional input device, comprising:
a conductive elastomeric textile construction (1) having an intuitive user interface (10),
wherein said intuitive user interface (10) has an actuator (30) cooperative with one or more conductive areas (25).

11. The multi-direction proportional input device of claim 10, wherein one or more characteristics of said one or more conductive areas (25) change in response to an interaction via said actuator (30).

12. The multi-direction proportional input device of claim 10, wherein said interface (10) is connected to a textile surface (5).

13. The multi-direction proportional input device of claim 10, wherein said interface (10) is integral with a textile surface (5).

14. The multi-direction proportional input device of claim 11, wherein any relative movement of said one or more conductive areas (25) is detectable via said change in the characteristics thereof.

15. The multi-direction proportional input device of claim 14, wherein a displacement ratio between said one or more conductive areas (25) is used to quantify the degree of said interaction and/or to quantify the speed or rate of said interaction.

16. A garment having the input device of claim 15.

17. A garment having the input device of claim 10, said input device being suitable for use in a variety of different wearable electronic applications and/or for accomplishing one or more different complex functionalities requiring proportional input.

18. A method for forming a multi-direction input device, comprising the steps of:
fashioning an interface (10) from a conductive elastomeric textile, said interface (10) having an actuator (30) for cooperating with one or more conductive areas (25) of said interface (10).

19. The method of claim 18, further comprising the step of connecting said interface (10) with a garment or upholstery cooperative with one or more electronic devices and/or systems.

20. The method of claim 18, wherein said interface (10) is integral to a garment or upholstery suitable for cooperating with one or more electronic devices and/or systems.
